(19) United States
(12) Patent Application Publication
(10) Pub. No.: US 2024/0320280 A1
(43) Pub. Date: Sep. 26, 2024

(54) INFORMATION PROCESSING APPARATUS

(71) Applicant: Toshiba Tec Kabushiki Kaisha, Tokyo (JP)

(72) Inventor: Masami TAKAHATA, Tokyo (JP)

(73) Assignee: Toshiba Tec Kabushiki Kaisha, Tokyo (JP)

(21) Appl. No.: 18/189,939

(22) Filed: Mar. 24, 2023

(51) Int. Cl. G06F 16/9535; G06F 16/9538

(52) U.S. Cl. CPC G06F 16/9535; G06F 16/9538

(57) ABSTRACT

An information processing apparatus including an action information generator, a tag specification device, a content specification device, and a correspondence information generator. The action information generator generates action information indicating each of a plurality of actions based on action-related information related to each of the plurality of actions of a user. The tag specification device specifies tags representing attributes of each of the plurality of actions based on the action information. The content specification device specifies the one or more contents related to at least one of the plurality of actions. The correspondence information generator generates correspondence information associated with the action information, the tags representing the attributes of each of the plurality of actions specified by the tag specification device, and the one or more contents specified by the content specification device.

### FIELD

Embodiments described herein relate generally to information processing apparatuses.

### BACKGROUND

An information processing apparatus searches for a content desired by a user based on a search key received from the user and displays the content obtained as a result of the search. However, in many cases, the search keys used to search for the content are attributes of information associated with the content such as content names, content creators, content creation dates, content edit dates, and the like. However, in many cases, when using information attributed to the content as the search key, the information processing apparatus cannot obtain the content desired by the user.

### BRIEF DESCRIPTION OF THE DRAWING

FIG. 1 is a diagram illustrating an example of a configuration of an information processing system according to one embodiment;

FIG. 2 is a diagram illustrating an example of a hardware configuration of an information processing apparatus according to one embodiment;

FIG. 3 is a diagram illustrating an example of a functional configuration of the information processing apparatus according to one embodiment;

FIG. 4 is a diagram illustrating content searched as target content by the information processing apparatus according to one embodiment;

FIG. 5 is a diagram illustrating an intermediate generation information generated from action-related information according to one embodiment;

FIG. 6 is a diagram illustrating the intermediate generation information generated from the action-related information according to another embodiment;

FIG. 7 is a diagram illustrating a result of extracting action information indicating an action performed by a user UA in a meeting X from action information generated by the information processing apparatus according to one embodiment;

FIG. 8 is a diagram illustrating a process of the action sensor detecting the action-related information according to one embodiment;

FIG. 9 is a diagram illustrating a flow of a process in which the information processing apparatus generates the action information and the correspondence information according to one embodiment;

FIG. 10 is a diagram illustrating tag information according to one embodiment;

FIG. 11 is a diagram illustrating the correspondence information according to one embodiment; and

FIG. 12 is a diagram illustrating the flow of a process for performing the search using the correspondence information according to one embodiment.

### DETAILED DESCRIPTION

In general, according to one embodiment, an information processing apparatus includes an action information generation unit, a tag specification unit, a content specification unit, and a correspondence information generation unit. The action information generation unit generates action information indicating each of one or more actions based on action-related information related to each of the one or more actions of a user. The tag specification unit specifies tags representing the attribute of each of the one or more actions based on the action information generated by the action information generation unit. The content specification unit specifies one or more contents related to at least one of the one or more actions based on the action information generated by the action information generation unit. The correspondence information generation unit generates correspondence information associated with the action information generated by the action information generation unit, the tags representing the attribute of each of the one or more actions specified by the tag specification unit, and the one or more contents specified by the content specification unit.

Hereinafter, an information processing system according to the embodiment will be described with reference to the drawings. In each drawing, the same components are denoted by the same reference numerals. An information processing system 1 will be described as an example of the information processing system according to at least one embodiment. For the convenience of explanation, a user of the information processing system 1 will be simply referred to as a user.

### (Configuration of Information Processing System)

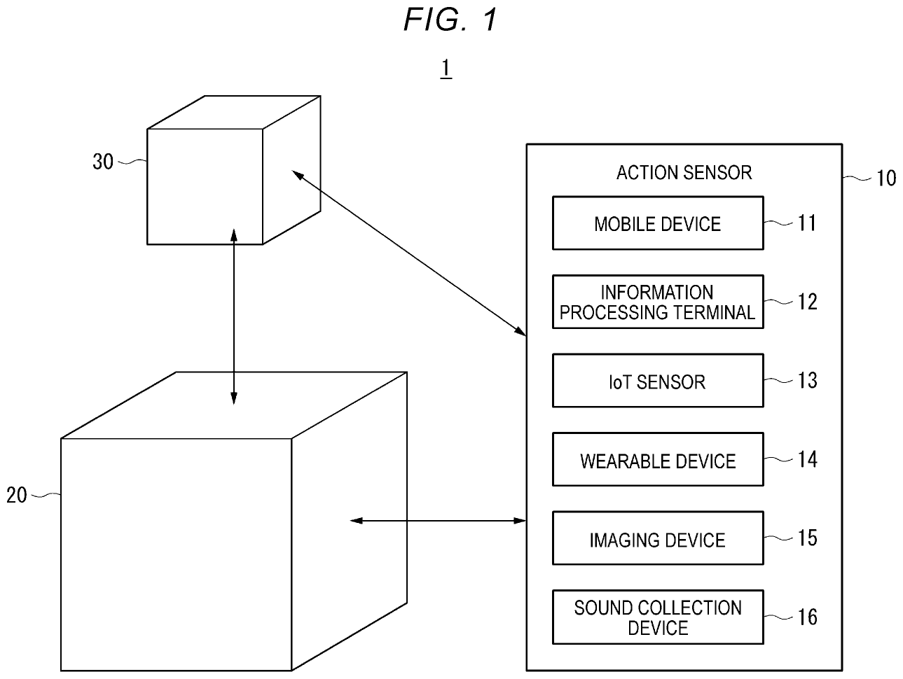

A configuration of the information processing system 1 will be described with reference to FIG. 1.

FIG. 1 is a diagram illustrating an example of the configuration of the information processing system 1. The information processing system 1 includes an action sensor 10, an information processing apparatus 20, and a server 30.

The information processing system 1 improves efficiency of work within a company in which the information processing system 1 is installed. Specifically, the information processing system 1 can assist in searching for the content related to the action of a user within the company and can allow the user to easily search for the content desired by the user with high accuracy. For example, the information processing system 1 enables searching for the content by character strings including character strings representing when “who” (e.g., a person, the user, etc.) is doing “what” (e.g., an action, a task, etc.). The information processing system 1 may receive the character string by a voice input device such as a microphone or may receive the character string by an input device such as a keyboard or a touch panel. The information processing system 1 may be configured to search for the content related to the action of the user during a non-work time instead of being configured to search for the content related to the action of the user during a work time. Here, the information processing system 1 can improve search efficiency of the content by the user and can allow the user to easily search for the content desired by the user with high accuracy.

The action sensor 10 detects one or more action-related information about a predetermined user. For the convenience of explanation, the user is referred to as a user UA. The user UA is one of the one or more users and may be any user. The one or more action-related information about the user UA is information about each of the one or more actions of the user UA. For example, the action-related information among the one or more action-related information is information related to the action among the one or more actions. That is, each of the action-related information included in the one or more action-related information is associated with any one of the one or more actions of the user UA. Therefore, the action-related information about the user UA includes user identification information that identifies the user UA. The process of including the user identification information in the action-related information may be performed by the action sensor 10 outputting the action-related information or may be performed by the information processing apparatus 20 acquiring the action-related information from the action sensor 10.

The action sensor 10 may be configured to detect the action-related information for each of the plurality of users. Here, the action sensor 10 may be configured as a separate sensor detecting the action-related information of the user for each of the plurality of users and may be configured as a single sensor detecting the action-related information of the user for each of the plurality of users. Here, each action-related information output from the action sensor 10 includes the user identification information that identifies the user. Accordingly, in the information processing system 1, it is possible to identify which action-related information is the action-related information about which user.

The action-related information includes, for example, information indicating going to the office, information indicating leaving the office, schedule information indicating a schedule, information indicating sitting on a seat of the user, information indicating leaving the seat of the user, information indicating various operations performed on a personal computer (PC), various information input to the PC, various information output from the PC, information indicating attendance in a meeting, voice data or video data indicating remarks in the meeting, and the like, but not limited thereto. Which information is to be detected by the action sensor 10 as the one or more action-related information is determined in advance by the user UA, the company to which the user UA belongs, and the like. Therefore, the action sensor 10 is configured to include one or more devices that can detect the information predetermined by the user UA or the like as the action-related information. In the example illustrated in FIG. 1, the action sensor 10 includes six devices of a mobile device 11, an information processing terminal 12, an IoT sensor 13, a wearable device 14, an imaging device 15, and a sound collection device 16. Each of the one or more devices included in the action sensor 10 may be referred to as a sensor.

The mobile device 11 is, for example, a multifunctional mobile phone terminal (e.g., a smartphone), a mobile phone terminal, a tablet personal computer (PC), a personal digital assistant (PDA), or the like, but not limited thereto. Among the action-related information about the user UA, the action-related information detected by the mobile device 11 is, for example, a portion or all of the information indicating a location of the user UA, the information indicating whether the user UA is moving, and the like, but not limited thereto.

The information processing terminal 12 is, for example, a desktop PC, a notebook PC, a workstation, or the like, but not limited thereto. Among the action-related information about the user UA, the action-related information detected by the information processing terminal 12 is, for example, information indicating an operation log or the like, but not limited thereto. For example, the information indicating the operation log may include the information indicating the operation received by the information processing terminal 12 from the user, information indicating various search histories, and the like. The information indicating the operation received by the information processing terminal 12 from the user includes information indicating operations to an OS (e.g., operating system) of the information processing terminal 12, information indicating operations to various contents on the information processing terminal 12, and the like. The information indicating the operation to the various contents is, for example, application operation information indicating operations to an application program that opens the contents, content operation information indicating operations to the contents opened by the application program, and the like, but not limited thereto. The operation to the content opened by the application program includes browsing, edition, deletion, or the like by the user UA, but not limited thereto. The various contents include, for example, documents browsed by the user UA, websites browsed by the user UA, sent e-mails, received e-mails, character strings written in chats, or the like, but not limited thereto. The information processing apparatus 20 described later can specify each of the application programs and contents operated by the user UA on the information processing terminal 12 based on the information indicating the operation log acquired from the information processing terminal 12 as the action-related information. For the convenience of explanation, the application program is simply referred to as an application.

The information processing terminal 12 outputs the information indicating the content operated by the user UA to the server 30. For example, the information processing terminal 12 may be configured to output the content itself operated by the user UA as the information indicating the content operated by the user UA to the server 30. For example, the information processing terminal 12 may be configured to output the information capable of designating the content such as a uniform resource locator (e.g., a URL) as the information indicating the content operated by the user UA to the server 30. The server 30 (described later) acquires the information indicating the content output from the information processing terminal 12 as such and stores the information in the storage area of the server 30. The information indicating the content operated by the user UA may be configured to be output to the server 30 through the information processing apparatus 20.

The IoT sensor 13 is, for example, an environment sensor such as a pressure sensitive sensor, a temperature sensor, or a carbon dioxide sensor, but not limited thereto. Among the action-related information about the user UA, the action-related information detected by the IoT sensor 13 includes, for example, the information indicating pressure applied by the user UA, the information indicating temperature changed due to the action of the user UA, and the information indicating carbon dioxide concentration changed due to the action of the user UA, but not limited thereto.

The wearable device 14 is, for example, a smart watch, smart glasses, or the like, but not limited thereto. Among the action-related information about the user UA, the action-related information detected by the wearable device 14 is, for example, the information indicating the heart rate of the user UA, the information indicating the number of steps taken by the user UA, or the like, but not limited thereto.

The imaging device 15 is a camera including, for example, a charge coupled device (CCD), a complementary metal oxide semiconductor (CMOS), or the like, as an imaging element converting condensed light into an electrical signal. The imaging device 15 may be configured to form a still image or may be configured to form a moving image. Among the action-related information about the user UA, the action-related information detected by the imaging device 15 is, for example, a portion or all of the information indicating a facial expression of the user UA, the information indicating a movement of the user UA, and the like, but not limited thereto.

The sound collection device 16 is a voice input unit (e.g., voice input device, microphone, etc.). Among the action-related information about the user UA, the action-related information detected by the sound collection device 16 is, for example, a portion or all of the information indicating remarks of the user UA, the information indicating a voice waveform of the user UA, and the like, but not limited thereto.

The action sensor 10 outputs the action-related information detected by each of the one or more devices included in the action sensor 10 to the information processing apparatus 20. The action sensor 10 may be configured to include a device aggregating the action-related information detected by each of the one or more devices and may be configured to allow the device to output the action-related information aggregated by the device to the information processing apparatus 20. The action sensor 10 may be configured to output the action-related information detected by each of the one or more devices included in the action sensor 10 from each of the one or more devices to the information processing apparatus 20.

The information processing apparatus 20 is a stationary information processing apparatus such as a server, a workstation, or a desktop PC, but not limited thereto. The information processing apparatus 20 may be a mobile information processing apparatus such as a notebook PC, a tablet PC, a multifunctional mobile phone terminal, or the like.

The information processing apparatus 20 is communicably connected to the action sensor 10 via a network or the like. The information processing apparatus 20 is communicably connected to the server 30 via the network or the like. The information processing apparatus 20 may be configured integrally with one or both of the action sensor 10 and the server 30.

The information processing apparatus 20 acquires the action-related information detected by each of the one or more devices included in the action sensor 10. The information processing apparatus 20 generates the action information indicating each of the one or more actions of the user UA based on the acquired one or more action-related information. After generating the action information, the information processing apparatus 20 specifies the one or more contents related to at least one of the one or more actions of the user UA together while specifying the tag representing the attribute of each action of the user UA based on the generated action information. After specifying the tag and the one or more contents, the information processing apparatus 20 generates correspondence information associated with the action information, the tag, and the one or more contents. Accordingly, the information processing apparatus 20 can allow the user to search for the content based on the correspondence information. As a result, the information processing apparatus 20 can provide the content desired by the user to the user with high accuracy.

Specifically, after generating the correspondence information, the information processing apparatus 20 receives the character string representing the target content, which is the content serving as a search target. After receiving the character string, the information processing apparatus 20 extracts words serving as the one or more search keys from the received character string. After extracting the words serving as the one or more search keys, the information processing apparatus 20 searches for the content presumed to be the target content among the one or more contents based on the extracted words serving as the one or more search keys and the generated correspondence information. Then, the information processing apparatus 20 outputs the information indicating the content obtained as a result of the search. Accordingly, the information processing apparatus 20 can provide the content desired by the user with higher accuracy to the user. The information processing apparatus 20 may be configured to output the content itself as the information indicating the content obtained as a result of the search. The information processing apparatus 20 may be configured to output the information, such as a URL, capable of designating the content as the information indicating the content obtained as a result of the search.

The server 30 may be any information processing apparatus as long as the server 30 can function as a server. The server 30 is a workstation, a desktop PC, a notebook PC, or the like, but not limited thereto. The server 30 is communicably connected to the information processing terminal 12 via the network or the like. The server 30 is communicably connected to the information processing apparatus 20 via the network or the like.

The server 30 acquires the information indicating the content from the information processing terminal 12. The server 30 stores the information indicating the content acquired from the information processing terminal 12 in the storage area of the server 30. In response to a request from a source, such as the information processing apparatus 20 or the information processing terminal 12, the server 30 outputs the information indicating the content stored in the storage area to the request source. That is, the server 30 is a server storing the one or more contents related to at least one of the one or more actions of the user UA.

### (Hardware Configuration of Information Processing Apparatus)

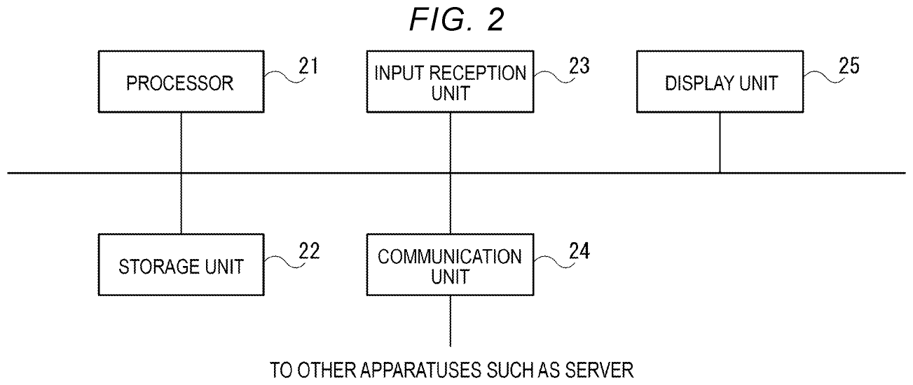

A hardware configuration of the information processing apparatus 20 will be described with reference to FIG. 2. FIG. 2 is a diagram illustrating the hardware configuration of the information processing apparatus 20 according to at least one embodiment.

The information processing apparatus 20 includes, for example, a processor 21, a storage unit (e.g., a computer readable storage medium, etc.) 22, an input reception unit (e.g. input receptor, input reception device, etc.) 23, a communication unit (e.g., communicator, communication device) 24, and a display unit (e.g., display) 25. Such components are communicatively connected to each other via a bus. The information processing apparatus 20 communicates with other devices such as an action sensor 10 and the server 30 via the communication unit 24.

The processor 21 is, for example, a central processing unit (CPU). The processor 21 may be another processor such as a field programmable gate array (FPGA) instead of the CPU. The processor 21 executes various programs stored in the storage unit 22. The processor 21 may be configured with the CPU included in one information processing apparatus (e.g., the information processing apparatus 20 in the present example), or may be configured with CPUs included in a plurality of the information processing apparatuses.

The storage unit 22 includes, for example, a hard disk drive (HDD), a solid state drive (SSD), an electrically erasable programmable read only memory (EEPROM), a read only memory (ROM), a random access memory (RAM), and the like. The storage unit 22 may be an external storage device connected by a digital input/output port such as a universal serial bus (USB) instead of being embedded in the information processing apparatus 20. The storage unit 22 stores various information, various programs, and the like processed by the information processing apparatus 20.

The input receptor 23 is an input device such as a keyboard, a mouse, or a touch pad. The input receptor 23 may be a touch panel configured integrally with the display 25. The input receptor 23 is an example of the receptor device. The input receptor 23 may be configured to include a sound collection device such as a microphone. Here, the input receptor 23 receives sound collected by the sound collection device as an input to the information processing apparatus 20.

The communication unit 24 includes, for example, a digital input/output port such as a USB, an Ethernet (registered trademark) port, and the like.

The display 25 is, for example, a display device including a display panel such as a liquid crystal display panel or an organic electro-luminescence (EL) display panel. The display 25 is an example of an output unit. The information processing apparatus 20 may be configured to include other output units such as a sound output unit instead of the display 25 or in addition to the display 25. The sound output unit is, for example, a speaker or the like.

### (Functional Configuration of Information Processing Apparatus)

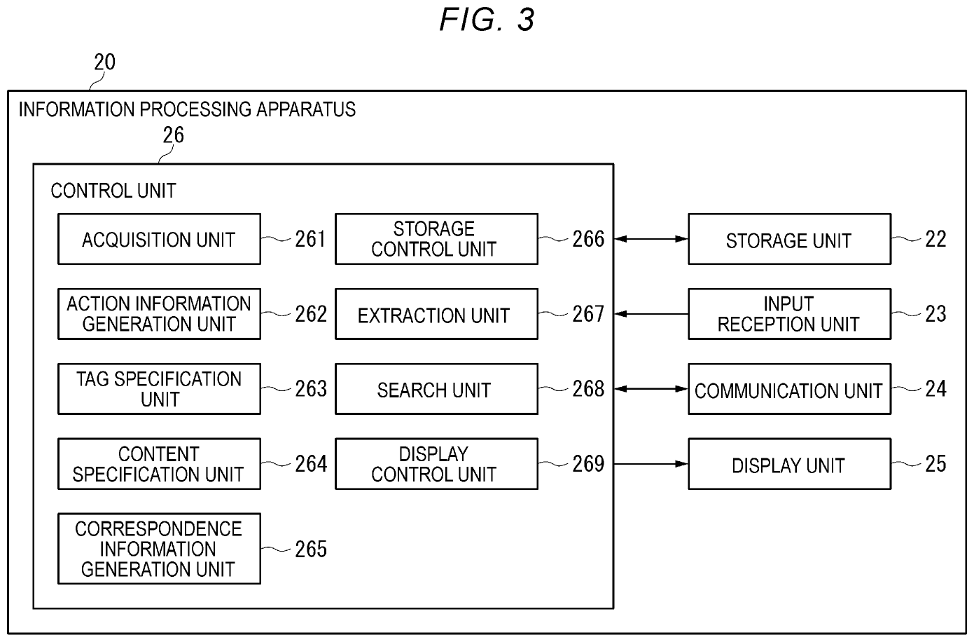

A functional configuration of the information processing apparatus 20 will be described with reference to FIG. 3. FIG. 3 is a diagram illustrating the functional configuration of the information processing apparatus 20 according to at least one embodiment.

The information processing apparatus 20 includes the storage unit (e.g., storage) 22, the input receptor 23, the communication unit 24, the display 25, and a control unit (e.g., control device, controller, etc.) 26.

The controller 26 controls the entire components of the information processing apparatus 20. The controller 26 includes an acquisition device 261, an action information generator 262, a tag specification unit 263, a content specification unit 264, a correspondence information generator 265, a storage controller 266, an extraction unit (e.g., extractor, extraction device, etc.) 267, a search unit (e.g., a searcher, a search device, etc.) 268. and a display controller 269. Such functional units included in the controller 26 are implemented, for example, by the processor 21 executing various programs stored in the storage unit 22. Some or all of the functional units may be hardware functional units such as large scale integration (LSI) and application specific integrated circuit (ASIC).

The acquisition unit 261 acquires the one or more action-related information about the user UA from the action sensor 10.

The action information generator 262 generates the action information indicating each of the one or more actions of the user UA based on one or more action-related information about the user UA acquired by the acquisition unit 261.

The tag specification unit 263 specifies the tags representing the attributes of the one or more actions of the user UA based on the action information generated by the action information generator 262.

The content specification unit 264 specifies the one or more contents related to at least one of the one or more actions of the user UA based on the action information generated by the action information generator 262.

The correspondence information generator 265 generates the correspondence information based on the action information generated by the action information generator 262, the tag specified by the tag specification unit 263, and the one or more contents specified by the content specification unit 264.

The storage controller 266 allows the storage unit 22 to store various types of information. For example, the storage controller 266 allows the storage unit 22 to store the correspondence information generated by the correspondence information generator 265.

The extraction unit (e.g., extractor) 267 extracts the words serving as the one or more search keys from the character string received by the input receptor 23.

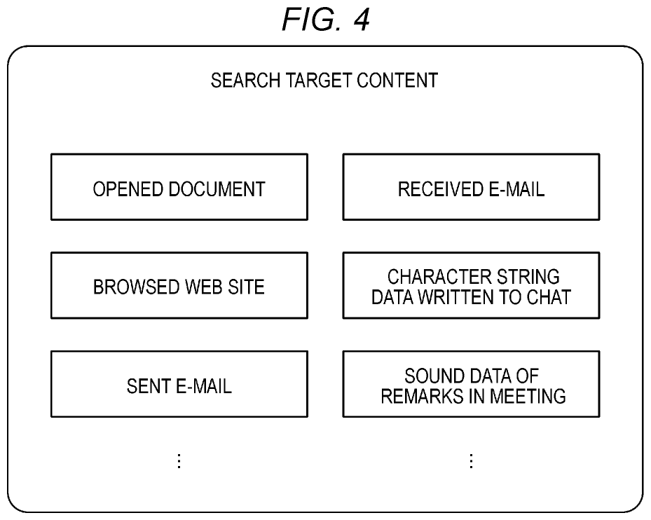

The searcher 268 searches for the content presumed to be the target content among the one or more contents based on the words serving as the one or more search keys extracted by the extraction unit 267 and the correspondence information stored in the storage unit 22. FIG. 4 is a diagram illustrating the content searched as the target content by the information processing apparatus 20 according to at least one embodiment. As illustrated in FIG. 4, the target content is, for example, a document opened on the PC of the user UA, an e-mail received on the PC, a website viewed on the PC, and a character string data written in a chat on the PC, a mail sent by the PC, voice data of remarks in a meeting, or the like, but not limited thereto.

The display controller 269 generates various images. The display controller 269 allows the display 25 to display the generated image. The display controller 269 is an example of the output control unit. For example, if the information processing apparatus 20 includes a speaker, the information processing apparatus 20 may be configured to include the display controller 269 and a sound output controller outputting sound from the speaker. Here, the information processing apparatus 20 includes the display controller 269 and the sound output controller as the output control units.

### (Action-Related Information and Action Information)

The information processing apparatus 20 acquires one or more action-related information detected by the action sensor 10 from the action sensor 10. Each of the action-related information acquired from the action sensor 10 by the information processing apparatus 20 includes, for example, a time stamp indicating the time of detection. The information processing apparatus 20 allows the storage unit 22 to store each of the one or more action-related information acquired from the action sensor 10 in the order of acquisition. The information processing apparatus 20 generates the intermediate generation information serving as the basis of the action information for each action-related information stored in the storage unit 22 based on the action-related information. The information processing apparatus 20 allows the storage unit 22 to store each of the intermediate generation information generated for each of the action-related information. The information processing apparatus 20 generates the action information based on the intermediate generation information stored in the storage unit 22. The information processing apparatus 20 may be configured to directly generate the action information based on the action-related information without the intermediate generation information. In the present embodiment, since the flow of processing is easy to understand, the case where the information processing apparatus 20 generates the action information through the intermediate generation information will be described.

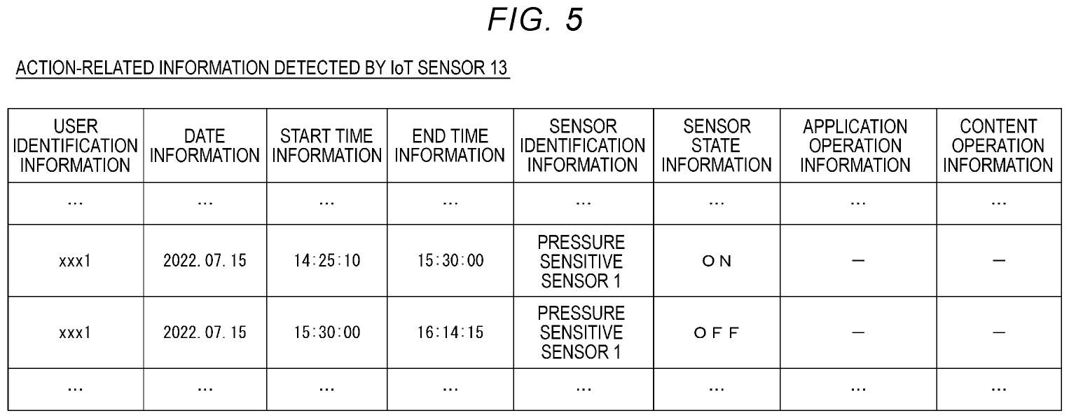

FIG. 5 is a diagram illustrating the intermediate generation information generated from certain action-related information according to at least one embodiment. Specifically, FIG. 5 is a diagram illustrating an example of the intermediate generation information based on the action-related information detected by the pressure sensitive sensor if the pressure sensitive sensor is included as the IoT sensor 13 in the action sensor 10. The pressure sensitive sensor is provided, for example, at the seat of the user UA. Here, if the user UA sits on the seat of the user UA, the pressure sensitive sensor receives pressure from the user UA. On the other hand, here, if the user UA leaves the seat of the user UA, the pressure sensitive sensor does not receive pressure from the user UA. Each time the predetermined sampling period elapses, the pressure sensitive sensor outputs the action-related information including the information indicating whether the pressure sensitive sensor is receiving pressure from the user UA together with the time stamp indicating the current date and time to the information processing apparatus 20. The sampling period is, for example, several hundred milliseconds, but not limited thereto. When acquiring the action-related information from the pressure sensitive sensor, the information processing apparatus 20 allows the storage unit 22 to store the acquired action-related information. For the convenience of explanation, if the pressure sensitive sensor receives pressure from the user UA, it is described to be referred to as the sensor state of the pressure sensitive sensor being ON. For the convenience of explanation, if the pressure sensitive sensor does not receive pressure from the user UA, the sensor state of the pressure sensitive sensor is OFF.

Each time the predetermined measurement period elapses, the information processing apparatus 20 generates the intermediate generation information about the pressure sensitive sensor based on the action-related information stored in the storage unit 22 within the elapsed measurement period. Specifically, the information processing apparatus 20 specifies the period of time as being from the time when the state of the pressure sensitive sensor is ON to the time when the state of the pressure sensitive sensor is OFF, and the period from the time when the state of the pressure sensitive sensor is OFF to the time when the state of the pressure sensitive sensor is ON. For example, the elapsed measurement period may be based on the action-related information stored in the storage unit 22 within a certain measurement period. The information processing apparatus 20 specifies the date including each specified period, the time when each specified period is started, and the time when each specified period is ended based on the time stamp included in the action-related information. The information processing apparatus 20 generates the information associated with date information, start time information, end time information, sensor state information, user identification information, sensor identification information, application operation information, and content operation information as the intermediate generation information for each specified period. The date information of a certain period is the information indicating the date of the period. The start time information of the period is the information indicating the time when the period is started. The end time information of the period is the information indicating the time when the period is ended. The sensor state information in the period is the information indicating the state of the pressure sensitive sensor in the period. The user identification information in the period is the user identification information included in the action-related information serving as the basis of the intermediate generation information. The sensor identification information in the period is the information for identifying the pressure sensitive sensor. In FIG. 5, the sensor identification information of the pressure sensitive sensor is indicated by a “pressure sensitive sensor 1”. The application operation information in the period is the information indicating the operation by the user UA to the application related to the state of the pressure sensitive sensor in the period. The content operation information for the period is the information indicating the operation by the user UA to the content related to the state of the pressure sensitive sensor in the period. However, there is no application related to the state of the pressure sensitive sensor and no content related to the state of the pressure sensitive sensor. Therefore, in the intermediate generation information of the pressure sensitive sensor, the application operation information and the content operation information are, for example, null information. In FIG. 5, the null information is indicated by “-”. That is, each record in the table illustrated in FIG. 5 indicates the intermediate generation information in each period specified by the information processing apparatus 20. The measurement period is, for example, one day, but the period may be shorter than one day or may be longer than one day.

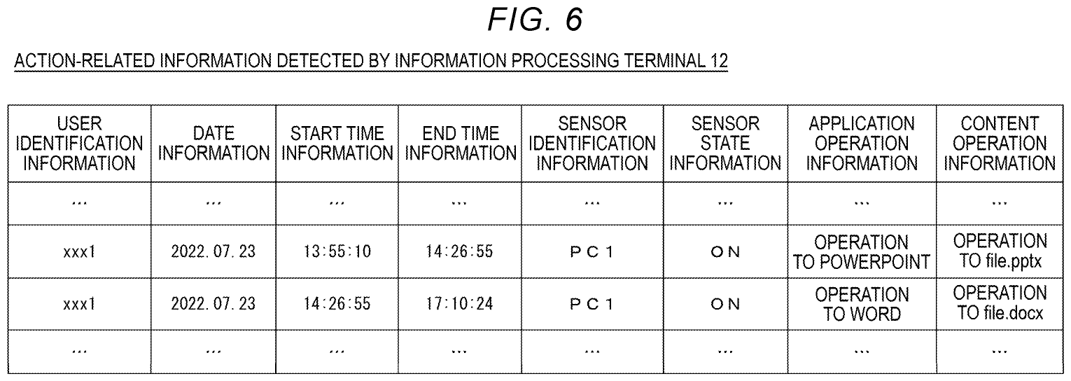

On the other hand, FIG. 6 is a diagram illustrating another example of the intermediate generation information generated from certain action-related information. Specifically, FIG. 6 is a diagram illustrating an example of the intermediate generation information based on the action-related information detected by the information processing apparatus 20 if the information processing terminal 12 is included in the action sensor 10. Here, the state of the information processing terminal 12 is distinguished by, for example, whether the power of the information processing terminal 12 is ON. For the convenience of explanation, the state in which the power of the information processing terminal 12 is ON is referred to as that the sensor state of the information processing terminal 12 is ON. For the convenience of explanation, the state in which the power of the information processing terminal 12 is OFF is referred to as that the sensor state of the information processing terminal 12 is OFF. The information processing terminal 12 outputs the action-related information including the information indicating the above-described operation log together with the time stamp indicating the date and time to the information processing apparatus 20 each time when the predetermined sampling period elapses. When acquiring the action-related information from the information processing terminal 12, the information processing apparatus 20 stores the acquired action-related information in the storage unit 22.

The information processing apparatus 20 generates the intermediate generation information about the information processing terminal 12 based on the action-related information stored in the storage unit 22 within the elapsed measurement period each time when the measurement period described above elapses. Specifically, for example, the information processing apparatus 20 specifies the period from the time when the application is activated to the time when the application is ended, for example, based on the information indicating the operation log included in the action-related information stored in the storage unit 22 within a certain measurement period for each application activated in the information processing terminal 12. The information processing apparatus 20 specifies the date including each specified period, the time when each specified period is started, and the time when each specified period is ended based on the time stamp included in the action-related information. The information processing apparatus 20 generates the information associated with the date information, the start time information, the end time information, the sensor state information, the user identification information, the sensor identification information, the application operation information, and the content operation information as the intermediate generation information for each specified period. The date information of a certain period is the information indicating the date of the period. The start time information of the period is the information indicating the time when the period is started. The end time information of the period is the information indicating the time when the period is ended. The sensor state information in the period is the information indicating the state of the information processing terminal 12 in the period. The user identification information in the period is the user identification information included in the action-related information serving as the basis of the intermediate generation information. The sensor identification information in the period is the information for identifying the information processing terminal 12. In FIG. 6, the sensor identification information of the information processing terminal 12 is indicated by a “PC 1”. The application operation information for the period is the information indicating the operation by the user UA to the application activated in the information processing terminal 12 during the period. In FIG. 6, the application operation information is indicated by an “operation to PowerPoint” and an “operation to Word”, respectively. The content information in the period is the information indicating the operation by the user UA to the content opened by the application in the period. In FIG. 6, the content operation information is indicated by an “operation to file.pptx” and an “operation to file.docx”, respectively. That is, each record in the table illustrated in FIG. 6 indicates the intermediate generation information in each period specified by the information processing apparatus 20 according to one embodiment.

As described in FIG. 5 and FIG. 6, the sensor state of each of the one or more devices included in the action sensor 10 is a device dependent state.

The configuration of the intermediate generation information for devices other than the pressure sensitive sensor and the information processing terminal 12 among the one or more devices included in the action sensor 10 is substantially the same as the configuration of the intermediate generation information illustrated in FIG. 5 and FIG. 6. For the convenience of explanation, the period from the time indicated by the start time information in certain intermediate generation information to the time indicated by end time information indicated by the intermediate generation information is referred to as an action period of the intermediate generation information.

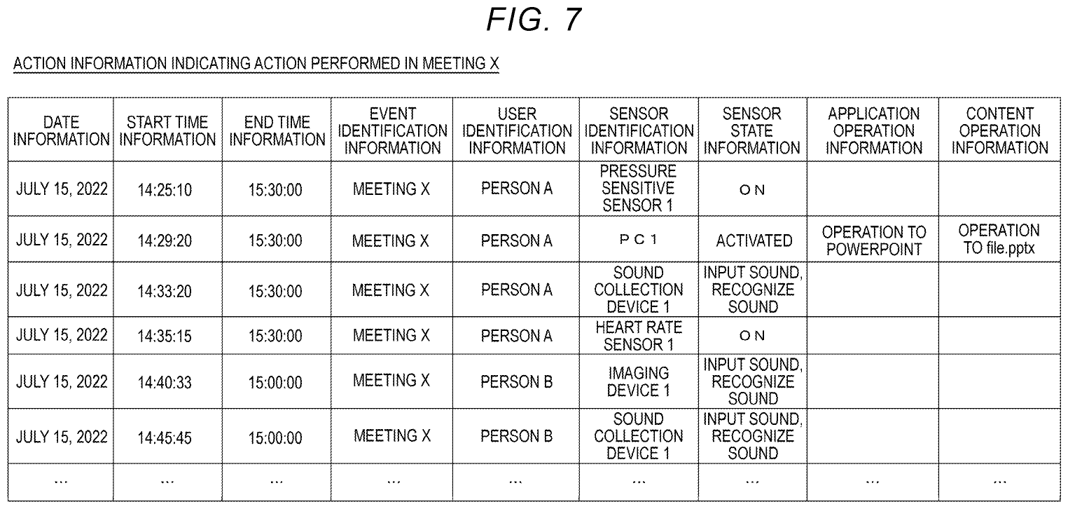

The information processing apparatus 20 generates the action information based on the intermediate generation information generated as such. FIG. 7 is a diagram illustrating a result of extracting the action information indicating the actions performed by the user UA in the meeting X from the action information generated by the information processing apparatus 20 according to one embodiment. The information processing apparatus 20 acquires the schedule information indicating the schedule of the user UA, for example, from the scheduler activated in the mobile device 11, the information processing terminal 12, or the like. The schedule information is also an example of the action-related information detected by the mobile device 11, the information processing terminal 12, or the like. The information processing apparatus 20 generates the action information based on the acquired schedule information and the intermediate generation information stored in the storage unit 22. Specifically, the information processing apparatus 20 specifies the one or more events performed by the user UA, for example, based on the schedule information. The one or more events are, for example, going to the office, leaving the office, meeting to attend, going out, or the like, but not limited thereto. The above-described meeting X is an example of the event specified by the information processing apparatus 20. As an example, a case where the event performed by the user UA is only the meeting X will be described. The information processing apparatus 20 specifies the intermediate generation information of the action period at least partially overlapping with the period of the meeting X specified as the event performed by the user UA as target intermediate generation information. For example, there may only be one target intermediate generation information. The information processing apparatus 20 generates the copy of the target intermediate generation information as the second target intermediate generation information. If the time indicated by the start time information of the generated second target intermediate generation information is earlier than the start time of the meeting X, the information processing apparatus 20 revises the start time information of the second target intermediate generation information to the information indicating the start time of the meeting X. On the other hand, if the time indicated by the start time information of the generated second target intermediate generation information is later than the start time of the meeting X, the information processing apparatus 20 retains the start time information of the second target intermediate generation information as it is. If the time indicated by the end time information of the generated second target intermediate generation information is later than the end time of the meeting X, the information processing apparatus 20 revises the end time information of the second target intermediate generation information to the information indicating the end time of the meeting X. On the other hand, if the time indicated by the end time information of the generated second target intermediate generation information is earlier than the end time of the meeting X, the information processing apparatus 20 retains the end time information of the second target intermediate generation information as it is. The information processing apparatus 20 generates the second target intermediate generation information after performing the processing on the start time information and the end time information and the information including the event identification information indicating the meeting X as the action information indicating the action performed by the user UA in the meeting X. The information processing apparatus 20 generates the action information for each of all the events specified from the schedule information by the method described above. The one or more action information generated as such are the action information indicating each of the one or more actions of the user UA in the meeting X, respectively. The information processing apparatus 20 allows the storage unit 22 to store the generated action information for each date indicated by the date information.

Each record of the table illustrated in FIG. 7 indicates each of the action information generated as described above according to one embodiment. That is, in the example illustrated in FIG. 7, the information processing apparatus 20 allows the storage unit 22 to store the generated action information as information in a table format. The information processing apparatus 20 may be configured to instruct the storage unit 22 to store the generated action information as information in a format different from the table format. In the table illustrated in FIG. 7, as the comparative example, included is the action information indicating the one or more actions of a user UB in addition to the action information indicating each of the one or more actions of the user UA. The user UB may be any user among the one or more users as long as the users are different from the user UA. In FIG. 7, the user identification information of the user UA is indicated by “person A”. In FIG. 7, the user identification information of the user UB is indicated by “person B”. In FIG. 7, the sensor identification information of the pressure sensitive sensor as the IoT sensor 13 is indicated by a “pressure sensitive sensor 1”. In FIG. 7, the sensor identification information of the information processing terminal 12 is indicated by a “PC 1”. In FIG. 7, the sensor identification information of the sound collection device 16 is indicated by a “sound collection device 1”. In FIG. 7, the sensor identification information of the heart rate sensor as the wearable device 14 is indicated by a “heart rate sensor 1”. In FIG. 7, the sensor identification information of the imaging device 15 is indicated by an “imaging device 1”.

For example, the record at the top of the table illustrated in FIG. 7 indicates the action of the user UA sitting in the seat of the user UA among the actions performed by the user UA in the meeting X. The reason is because the fact that the state of the pressure sensitive sensor ON in the period from 14:25:10 to 15:30:00 in the meeting X on Jul. 15, 2022 can be read from the information contained in the record. The fact indicates that the user UA sits in the seat of the user UA in the period.

For example, the second record from the top of the table illustrated in FIG. 7 illustrates an action of the user UA opening and operating a PowerPoint file “file.pptx” on the information processing terminal 12 among the actions performed by the user UA in the meeting X. The reason is because, from the information contained in the record, in a period from 14:29:20 to 15:30:00 in the meeting X on Jul. 15, 2022, the state of the information processing terminal 12 is ON, the application operation information indicates the “operation to PowerPoint”, and the content operation information indicates the “operation to file.pptx”. The fact indicates that the user UA opens and operates the PowerPoint file “file.pptx” in the period by using the information processing terminal 12.

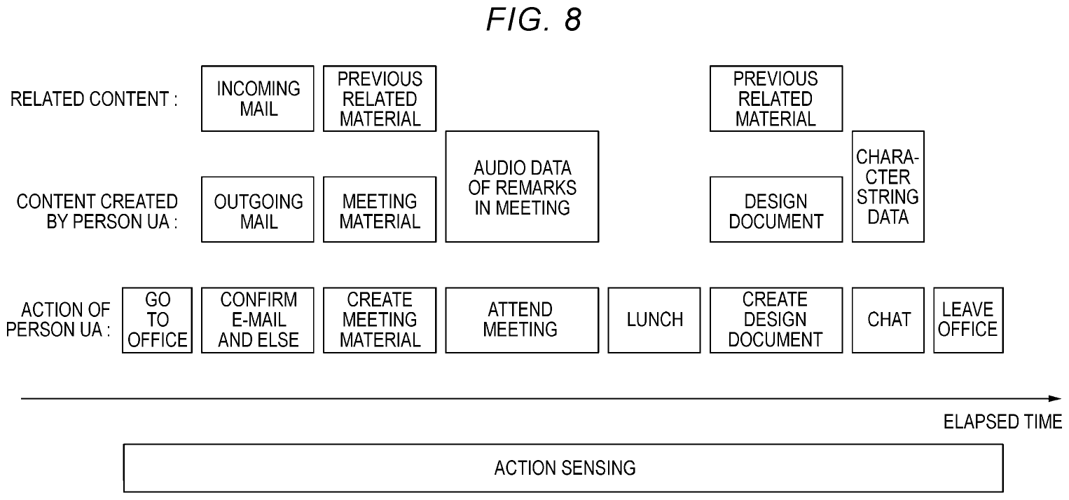

FIG. 8 is a diagram illustrating an aspect in which the action sensor 10 detects the action-related information on a certain day according to one embodiment. The horizontal axis illustrated in FIG. 8 indicates the elapsed time of the day. In FIG. 8, the user UA is indicated by “person UA”. In FIG. 8, the action sensor 10 starts detecting the action-related information approximately at the same time as the user UA goes to the office and ends detecting the action-related information approximately at the same time as the user UA leaves the office. In FIG. 8, the detection of the action-related information by the action sensor 10 is indicated by “action sensing”.

For example, if the IoT sensor 13 of the action sensor 10 is the above-described pressure-sensitive sensor, the action sensor 10 detects the action-related information related to whether the user UA sits on the seat of the user UA when going to the office.

For example, the action sensor 10 detects the action-related information related to the transmission of e-mails performed by the user UA in the period if the user UA is checking the e-mails. The action-related information includes, for example, the information indicating the operation to a mailer such as Outlook as the application operation information. The action-related information includes, for example, the information indicating the operation to send the e-mail and the information indicating the operation to receive the e-mail as the content operation information. In FIG. 8, the sent e-mail is indicated by a “sent e-mail”. The sent e-mail is detected by the information processing terminal 12 as a content created by the user UA. In FIG. 8, the received e-mail is indicated by a “received e-mail”. The received e-mail is detected by the information processing terminal 12 as the content related to the checking of the e-mail performed by the user UA. These contents are also examples of the contents operated by the user UA, that is, the contents related to the actions of the user UA.

As such, the action sensor 10 detects the action-related information about the action of the user UA in the company each time when the sampling period elapses and outputs the detected action-related information to the information processing apparatus 20. Accordingly, the information processing apparatus 20 can generate the action information indicating each of the one or more actions of the user UA based on the action-related information acquired from the action sensor 10.

### (Processing for Generating Action Information and Correspondence Information)

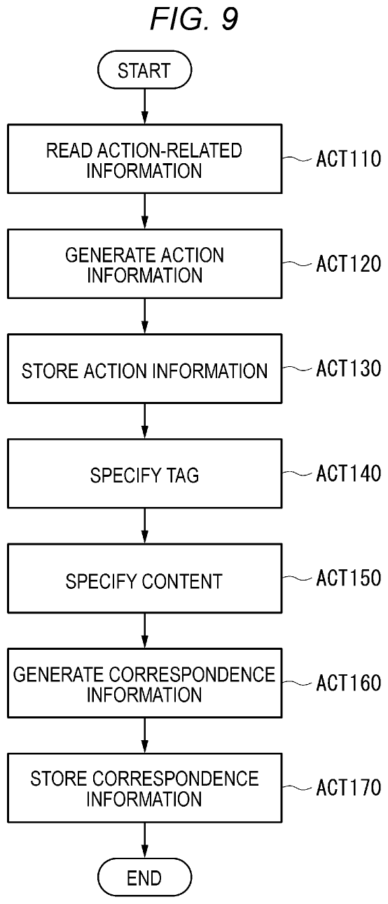

FIG. 9 is a diagram illustrating the flow of processing in which the information processing apparatus 20 generates the action information and correspondence information according to one embodiment. In FIG. 9, before the process of ACT110 is performed, all the action-related information detected by the action sensor 10 within a certain measurement period XA are stored in the storage unit 22.

After the measurement period XA elapses, the action information generation unit 262 reads out all the action-related information detected by the action sensor 10 within the measurement period XA from the storage unit 22 based on the time stamps included in the action-related information (ACT110).

Next, the action information generator 262 generates the above-described intermediate generation information based on all the action-related information read in ACT110. Then, the action information generator 262 generates the action information indicating each of the one or more actions of the user UA within the measurement period XA based on the generated intermediate generation information (ACT120). Since the method of generating the action information was already described, herein, the detailed description thereof will be omitted.

Next, the action information generator 262 allows the storage unit 22 to store the action information generated in ACT120 (ACT130).

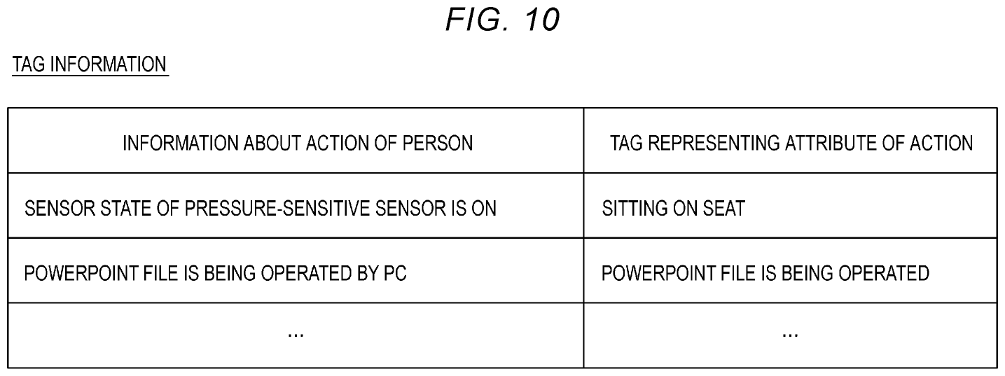

Next, the tag specification unit 263 specifies the tags representing the attributes of the action indicated by each of the action information stored in the storage unit 22 in ACT130 (ACT140). Specifically, the tag specification unit 263 reads the tag information stored in advance in the storage unit 22. The tag information is information associated with the information about the action and the tag representing the attribute of the action for each action of the person. The tag specification unit 263 specifies the tag representing the attribute of the action indicated by each of the action information based on the read tag information and the action information. For example, the information indicating that the sensor state of the pressure-sensitive sensor provided in a certain seat is ON is an example of the information indicating that the person sits on that seat, that is, the information related to the action of the person. Therefore, in the tag information, for example, the information indicating that the sensor state of the pressure-sensitive sensor provided in a certain seat is ON is associated with the tag representing the attribute of “sitting on the seat”. For example, the information indicating that the PowerPoint file is being opened by the PC is the information indicating that the file is being edited by the PC, that is, an example of the information related to the action of the person. Therefore, in the tag information, for example, the information indicating that the PowerPoint file is being operated by a certain PC is associated with the tag representing the attribute of “PowerPoint file is being operated”. FIG. 10 is a diagram illustrating an example of such tag information according to one embodiment. Therefore, in ACT140, the tag specification unit 263 extracts the information about the action of the person from each of the action information stored in the storage unit 22 in ACT130 and specifies the tag corresponding to the extracted information based on the tag information. The tag information may be table format information or other format information. The information processing apparatus 20 may be configured to be able to add, edit, and delete tag information according to the operation received from the user.

Next, the content specification unit 264 specifies the one or more contents related to at least one of the actions indicated by each of the action information based on the action information stored in the storage unit 22 in ACT130 (ACT150). Specifically, for each of the action information, the content specification unit 264 specifies the content operated by the user UA as the content related to the action indicated by the action information based on the content operation information included in the action information. However, if the content operation information included in certain action information is null information, the content specification unit 264 specifies that there is no content related to the action indicated by the action information. After specifying the content related to the action indicated by a certain action information, the content specification unit 264 replaces the content operation information included in the action information with the content information indicating the content. The content specification unit 264 replaces the application operation information included in the action information with the application information indicating the application receiving the operation indicated by the application operation information. The content specification unit 264 performs such replacement of the content operation information with the content information and such replacement of the application operation information with the application information for each action information. The content information indicating a certain content may be any information as long as content information can indicate the content. The application information indicating a certain application may be any information as long as the application information can indicate the application.

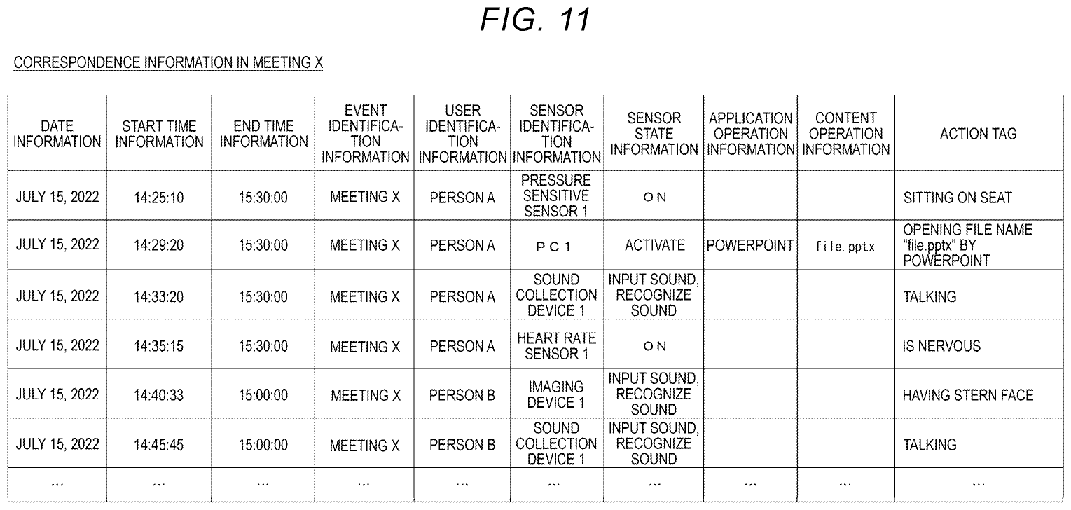

Next, the correspondence information generator 265 generates the correspondence information based on the action information after the replacement in ACT150 and the tag specified in ACT140 (ACT160). Specifically, the correspondence information generator 265 associates each of the action information with the tag representing the attribute of the action indicated by the action information. FIG. 11 is a diagram illustrating the correspondence information according to one embodiment. The correspondence information illustrated in FIG. 11 is the correspondence information generated by the correspondence information generator 265 according to the action information illustrated in FIG. 7. In the correspondence information illustrated in FIG. 11, a field which is the application operation information is replaced with the application information in FIG. 7. In the correspondence information illustrated in FIG. 11, a field which is the content operation information is replaced with the content information in FIG. 7. Each record of the correspondence information illustrated in FIG. 11 is added with a field in which the tag representing the attribute of the action indicated by the action information is stored. In FIG. 11, a field name for storing the tag is indicated by an “action tag”. The correspondence information may be information in another format instead of the information in the table format. Similarly, to the table illustrated in FIG. 11, the correspondence information generator 265 generates the action information after replacement in ACT150 and the information associated with the tags specified in ACT140 as the correspondence information.

Next, the storage controller 266 allows the storage unit 22 to store the correspondence information generated by the content specification unit 264 in ACT160 (ACT170), and the processing of the flowchart illustrated in FIG. 9 ends.

As such, the information processing apparatus 20 generates the correspondence information based on the action-related information related to each of the one or more actions of the user UA. Accordingly, the information processing apparatus 20 can allow the user UA to perform the search based on the correspondence information. As a result, the information processing apparatus 20 can assist in searching for the content related to the action of the user UA and can allow the user UA to easily search for the content desired by the user UA with high accuracy.

### (Processing for Searching Using Correspondence Information)

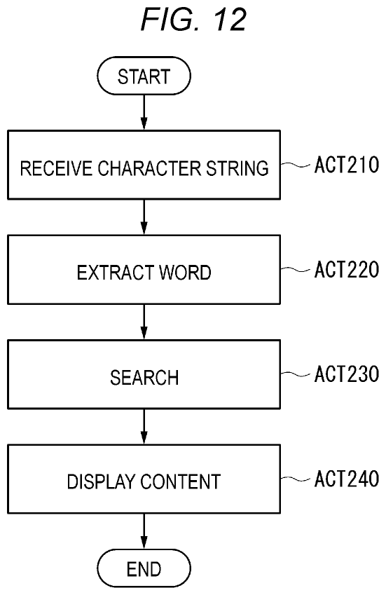

FIG. 12 is a diagram illustrating the flow of processing for performing the search using the correspondence information according to one embodiment. An example will be described where the correspondence information is stored in the storage unit 22 at the timing before the processing of ACT210 illustrated in FIG. 12. An example will be described where the information processing apparatus 20 receives the search start operation for allowing the information processing apparatus 20 to start the search using the correspondence information at the timing.

After receiving the search start operation, controller 110 receives the character string representing certain target content, which is content serving as the search target through input receptor 23 (ACT210). In other words, in ACT210, the input receptor 23 receives the character string. In FIG. 12, the processing of ACT210 is indicated by “character string reception”. The character string representing the target content is the character string including the character string representing when who is doing what. For example, the character string representing the target content is a character string that “find materials used when I am giving the presentation while being nervous in the meeting X at 14:30 on July 15”. Here, “I” is a character string representing “who” and is also a character string representing the user UA. Here, “14:30 on July 15” is a character string representing “what time”. Here, “giving the presentation while being nervous in the meeting X” is a character string representing “what is the person doing?”. For example, the character string representing the target content is a character string that “find materials used when person B is commenting with a stern face in the meeting X from 14:30 on July 15”. Here, “person B” is a character string representing “who” and is also a character string representing the user UB described above. Here, “14:30 on July 15” is a character string representing “what time”. Here, “commented with a stern face in a meeting X” is a character string representing that “what is the person doing?”. As described above, the input reception unit 23 may receive such character strings from the input device such as a keyboard, or may receive such character strings from the voice input unit such as a microphone. When receiving such a character string from the voice input unit, the input receptor 23 converts the voice input via the voice input device into the character string and receives the character string obtained by the conversion. The methods of achieving the above may be known methods or methods to be developed from now.

Next, the extraction unit 267 extracts words serving as the one or more search keys by a natural language analysis from the character string received by the input reception unit 23 in ACT210 (ACT220). In FIG. 12, the processing of ACT220 is indicated by “word extraction”. The words serving as the one or more search keys are, for example, character strings representing “who”, “when” “who” is doing “what”, but not limited thereto. A method of extracting the words serving as the one or more search keys by the extraction unit 267 may be a known method or may be a method to be developed from now.

Next, the searcher 268 searches for the target content based on the one or more words extracted by the extraction unit 267 in ACT220 and the correspondence information stored in advance in the storage unit 22 (ACT230). In FIG. 12, the processing of ACT230 is indicated as “search”. Specifically, the search unit 268 specifies the one or more records that are presumed to be the records containing the one or more words among the records indicating the correspondence information. Such inferences are performed, for example, by using the tags. That is, the searcher 268 specifies the one or more records presumed to be records containing the one or more words by comparing the one or more words with the tags included in the correspondence information. The searcher 268 specifies the content indicated by the content information included in each of the specified one or more records as candidates for the target content. The searcher 268 may perform specification of such candidates for the target content by using, for example, a machine learning model or may perform specification by using other methods.

Next, the display controller 269 generates the image including the information indicating the candidates of the target content specified in ACT230 and allows the display 25 to display the generated image (ACT240). In FIG. 12, the processing of ACT240 is indicated by “content display”. For example, if the character string received by the input receptor 23 is “find materials used when I am giving a presentation while being nervous in the meeting X from 14:30 on July 15”, the display controller 269 allows the display 25 to display an image containing the character string “the materials used when person A is giving a presentation while being nervous in the meeting X at 14:30 on July 15th will be file.pptx” as a result of the search. For example, if the character string received by the input receptor 23 is “find materials used when person B is commenting with a stern face in the meeting X at 14:30 on July 15”, the display controller 269 allows the display 25 to display an image containing the character string “the materials used when person B is commenting with a stern face in the meeting X on July 15th at 14:30 will be file.pptx” as a result of the search. If the information processing apparatus 20 includes the sound output unit and the sound output controller, the sound output control device may be configured to generate the sound including the information indicating the candidate of the target content specified in ACT230 in ACT240 and output the generated sound to the sound output unit. That is, the information processing apparatus 20 may be configured to output the information by a dialogue UI which is a user interface (UI) for bidirectionally inputting and outputting the information with the user UA by sound. After the processing of ACT240 is performed, the controller 110 performs the processing of the flowchart illustrated in FIG. 12 is ended.

As such, the information processing apparatus 20 searches for the target content based on the correspondence information and allows the display 25 to display the information indicating the candidates for the target content obtained as a result of the search. As a result, the information processing apparatus 20 can assist in searching for the content related to the action of the user UA and can allow the user UA to easily search for the content desired by the user UA with high accuracy.

In the example described above, the device such as the information processing terminal 12 included in the action sensor 10 is configured to store the information indicating content in the server 30. However, the information indicating the content to be stored in the server 30 may be stored from the information processing apparatus 20 or may be stored from another stand-alone device. Here, for example, voice data stored by the voice recorder is stored in the server 30 via short-range wireless communication, a flash memory, or the like.

The information processing apparatus 20 described above may be configured to receive the action from the user and to perform addition, change, deletion, or the like on the correspondence information according to the received action. Here, for example, the association of the voice data stored by the above-described voice recorder with the correspondence information is performed by the information processing apparatus 20 editing the correspondence information according to the action of the user.

The information processing system 1 described above may be applied to a robot. Here, some or all of the one or more devices included in the action sensor 10 are provided in the robot. Here, for example, the robot specifies the content desired by the user among the correspondence information by voice input from the user and performs the operation according to the specified content. For example, such operations include movement of the robot corresponding to the specified content, voice output by the robot corresponding to the specified content, and the like, but not limited thereto.

As described above, the information processing apparatus (e.g., the information processing apparatus 20 in the example described above) according to the embodiment includes an action information generator (e.g., the action information generator 262 in the example described above), a tag specification unit (e.g., the tag specification unit 263 in the example described above), a content specification unit (e.g., the content specification unit 264 in the example described above), and a correspondence information generator (e.g., the correspondence information generation unit 265 in the example described above). The action information generator 262 generates the action information indicating each of the one or more actions based on the action-related information related to each of the one or more actions of the user. The tag specification unit 263 specifies the tags representing the attributes of the one or more actions based on the action information generated by the action information generator. The content specification unit 264 specifies the one or more contents related to at least one of the one or more actions based on the action information generated by the action information generator 262. The correspondence information generator 265 generates the correspondence information associated with the action information generated by the action information generator 262, the tags representing the attributes of the one or more actions specified by the tag specification unit 263, and the one or more contents specified by the content specification unit 264. Accordingly, the information processing apparatus can allow the user to perform the search based on the correspondence information. As a result, the information processing apparatus can assist in searching for the content related to the action of the user and can allow the user to easily search for the content desired by the user with high accuracy.

In the information processing apparatus, a configuration may be used in which the schedule information indicating the schedule is included in the action-related information.

As the information processing apparatus, a configuration may be used in which the information processing apparatus includes an acquisition unit (e.g., the acquisition unit 261 in the example described above) acquiring action-related information, in which at least one of the action-related information is detected from the one or more sensors (e.g., the mobile device 11, the information processing terminal 12, the IoT sensor 13, the wearable device 14, the imaging device 15, and the sound collection device 16 in the example described above), and in which the acquisition device 261 acquires at least one of the action-related information from the one or more sensors.

In the information processing apparatus, a configuration may be used in which the one or more sensors include a wearable sensor (e.g., the wearable device 14 in the example described above).

In the information processing apparatus, a configuration may be used in which the tag specification unit 263 specifies the tag representing the attribute of each of the one or more actions of the user based on the tag information associated with the information about the action and the tag representing the attribute of the action for each action of the person and the action information generated by the action information generator 262.

As the information processing apparatus, a configuration may be used in which the information processing apparatus includes a storage controller (e.g., the storage control unit 266 in the example described above) that allows the storage device 22 to store the correspondence information generated by the correspondence information generator 265.

As the information processing apparatus, a configuration may be used in which information processing apparatus includes a receptor (e.g., the input receptor 23 in the example described above) receiving the character string representing the target content which is a content serving as the search target, an extraction unit (e.g., the extraction unit 267 in the example described above) extracting the words serving as the one or more search keys from the character string received by the receptor, a searcher (e.g., the searcher 268 in the example described above) searching for the content that is presumed to be the target content among the one or more contents based on the words serving as the one or more search keys extracted by the extraction unit and the correspondence information generated by the correspondence information generator, and an output controller (e.g., the display controller 269 in the example described above) outputting the information indicating the content obtained as a result of the search by the searcher 268 to the output unit (e.g., the display 25 in the example described above).

In the information processing apparatus, a configuration may be used in which the extraction unit 267 extracts the words serving as the one or more search keys from the character string received by the reception unit by the natural language analysis.

In the information processing apparatus, a configuration may be used in which the character string received by the receptor is the character string including the character string representing when who is doing what.

In the information processing apparatus, a configuration may be used in which the reception unit converts voice input through the voice input unit into the character string and receives the character string obtained by the conversion.

A portion of the functions of the information processing system 1, the action sensor 10, the information processing apparatus 20, and the server 30 in the above-described embodiment may be realized by a computer. Here, the program for realizing the functions is recorded on a computer-readable recording medium. Then, the functions may be realized by causing a computer system to read and execute the program recorded on a recording medium recording the above-described program. Note that the “computer system” referred to herein includes hardware such as an operating system and peripheral devices. The “computer-readable recording medium” refers to a portable medium, a storage device, or the like. The portable medium includes a flexible disk, a magneto-optical disk, a ROM, a CD-ROM, or the like. The storage device is a hard disk or the like incorporated in the computer system. The “computer-readable recording medium” is one that dynamically retains the program for the short period of time via a communication line like a communication line when transmitting the program. The communication line is a network such as the Internet or a telephone line. The “computer-readable recording medium” may be a volatile memory inside the computer system serving as the server or the client. The volatile memory retains a program for a certain period of time. The above-described program may be for realizing a portion of the functions described above. The above-described program may realize the functions described above in combination with the program already recorded in the computer system.

While certain embodiments have been described, these embodiments have been presented by way of example only, and are not intended to limit the scope of the inventions. Indeed, the novel embodiments described herein may be embodied in the variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to:
generate action information indicating each of a plurality of actions based on action-related information about each of the plurality of actions of a user;
specify a plurality of tags representing a plurality of attributes of each of the plurality of actions based on the action information;
specify a plurality of contents related to at least one of the plurality of actions based on the action information; and
generate correspondence information associated with the action information, the tags representing the attribute of each of the plurality of actions, and the plurality of contents.

2. The apparatus according to claim 1, wherein the action-related information includes schedule information indicating a schedule.

3. The apparatus according to claim 1, further configured to acquire the action-related information from at least one sensor, wherein the at least one sensor detects at least one action-related information.

4. The apparatus according to claim 3, wherein the at least one sensor includes at least one wearable sensor.

5. The apparatus according to claim 1, wherein the apparatus specifies at least one tag representing at least one attribute of each of the plurality of actions based on tag information associated with the action, and specifies the at least one tag representing the at least one attribute of the action and the action information for each action of the user.

6. The apparatus according to claim 1, further configured to store the correspondence information.

7. The apparatus according to claim 1, further configured to:
receive a character string representing a target content, the target content being a search target;
extract at least one word, each of the at least one words being one of a plurality of search keys from the character string;
search for the target content among a plurality of content based on the search keys and the correspondence information; and
output the information indicating the target content obtained as a result of the search.

8. The apparatus according to claim 7, wherein the words serving as the one or more search keys from the character string are extracted by a natural language analysis.

9. The apparatus according to claim 7, wherein the character string represents when a user is performing an action.

10. The apparatus according to claim 7, further configured to convert a voice input into the character string and receive the character string obtained by conversion.

11. A method of operating an information processing apparatus, the method comprising:
generating action information indicating each of a plurality of actions based on action-related information about each of the plurality of actions of a user;
specifying a plurality of tags representing a plurality of attributes of each of the plurality of actions based on the action information;
specifying a plurality of contents related to at least one of the one or more actions based on the action information; and
generating correspondence information associated with the action information, the tags representing the attribute of each of the plurality of actions, and the plurality of contents.

12. The method according to claim 11, wherein the action-related information includes schedule information indicating a schedule.

13. The method according to claim 11, further comprising:
acquiring the action-related information from at least one sensor, wherein the at least one sensor detects at least one action-related information.

14. The method according to claim 13, wherein the at least one sensor includes at least one wearable sensor.

15. The method according to claim 11, further comprising:
specifying at least one tag representing at least one attribute of each of the plurality of actions based on tag information associated with the action; and
specifying the at least one tag representing the at least one attribute of the action and the action information for each action of the user.

16. The method according to claim 11, further comprising storing the correspondence information.

17. The method according to claim 11, further comprising:
receiving a character string representing a target content, the target content being a search target;
extracting at least one word, each of the at least one words being one of a plurality of search keys from the character string;
searching for the target content among a plurality of content based on the search keys and the correspondence information; and
outputting the information indicating the target content obtained as a result of the search.

18. The method according to claim 17, wherein the words serving as the one or more search keys from the character string are extracted by a natural language analysis.

19. The method according to claim 17, wherein the character string represents when a user is performing an action.

20. The method according to claim 17, further comprising:
converting a voice input into the character string; and
receiving the character string obtained by conversion.
